(19) United States
(12) Patent Application Publication
(10) Pub. No.: US 2010/0309599 A1
(43) Pub. Date: Dec. 9, 2010

(54) LIGHTNING ARRESTOR APPARATUS

(75) Inventor: Chia-Jung Chen, Sindian City (TW)

Correspondence Address: HAMRE, SCHUMANN, MUELLER & LARSON, P.C., P.O. BOX 2902, MINNEAPOLIS, MN, 55402-0902, US

(73) Assignee: Grand-Tek Technology Co., Ltd, Sindian City (TW)

(21) Appl. No.: 12/478,169

(22) Filed: Jun. 4, 2009

(51) Int. Cl. H02H 3/22

(52) U.S. Cl. 361/119

(57) ABSTRACT

A lightning arrestor apparatus is disclosed, which is comprised of a connecting piece, a first coaxial cable, a second coaxial cable and a grounding lead. Said connecting piece comprises a first connecting end and second connecting end on both sides of said connecting piece. Said first coaxial cable comprises the first terminal to connect said first connecting end for transmitting signal. Said second coaxial cable comprises the second terminal to connect said second connecting end for transmitting signal above-mentioned. Said grounding lead is installed under said connecting piece. The exteriors of said first terminal and said first connecting end have been further wrapped with a first protection coating. The exteriors of said second terminal and said second connecting end have been further wrapped with a second protection coating. Thereby the invention not only can reduce the transmission loss, but also can avoid inappropriate assembly and moisture intrusion.

### FIELD OF THE INVENTION

The present invention relates to a lightning arrestor apparatus and, more particularly, to a lightning arrestor apparatus with lower transmission loss than the original design and good assembly to avoid moisture intrusion.

### BACKGROUND OF THE INVENTION

The lightning arrestor apparatus can rapidly leak abnormal high-voltage surge with several megavolt to the ground, which can avoid the power system being damaged. Upon said abnormal high-voltage disappears, a lightning arrestor apparatus will disconnect continuous current from the source to restore the OFF status.

FIG. 5 shows the structure of a conventional lightning arrestor apparatus, which both ends of body (100) separately install a threading section (101) and a connector (102). Said threading section (101) engages one-end connector (201) of a coaxial cable (200). Said connector (102) engages one-end threading part (301) of other coaxial cable (300), and comprises to connect with a grounding lead (not shown in figure) at the appropriate part of said body (100). Said coaxial cables (200) and (300) further connect to equipment under protection (not shown in figure). Signals can be transmitted in said body (100) and said coaxial cables (200) and (300) via this manner.

The present inventors further analyze according to the usage response to find out the engaging means using the structure of conventional lightning arrestor apparatus and said coaxial cables (200) (300). Upon long-term using, bad assembly causes severe transmission loss of signal plus moisture intrusion to break owing to instantaneous pressure. Therefore, it is desirable to improve the structure of conventional lightning arrestor.

### SUMMARY OF THE INVENTION

The purpose of present invention is to provide an improved lightning arrestor apparatus, which can directly transmit input signal to reduce transmission loss of said signal.

The other purpose of present invention is to provide a lightning arrestor apparatus, which can prevent bad assembly and moisture intrusion from causing a break owing to instantaneous pressure. Therefore, it can be used to protect internal components of said lightning arrestor apparatus and prevent damage.

In order to achieve the object, a lightning arrestor apparatus is created, which means are: a connecting piece including a first connecting end and a second connecting end on both sides of said connecting piece; a first coaxial cable including a first terminal to connect said first connecting end for transmitting signal; a second coaxial cable including a second terminal to connect said second connecting end for transmitting signal above-mentioned; and a grounding lead, which is installed under said connecting piece. The exteriors of said first terminal and said first connecting end have been further wrapped with a first protection coating. The exteriors of said second terminal and said second connecting end have been further wrapped with a second protection coating. Therefore, the effect of the present invention separately connects with the first terminal of first coaxial cable and the second terminal of second coaxial cable by means of both sides of said connecting piece that can more directly transmit the input signal to reduce transmission loss of said signal, which not only can wrap with first and second protection coating at the connecting part to enhance the assembly effect but also can prevent moisture intrusion from the explosion.

DETAILED DESCRIPTION OF THE PREFERRED EMBODIMENT

The contents and details of the present invention are described with drawings to list the concrete examples as follows:

Refer to FIG. 1 to FIG. 2. A better example of lightning arrestor apparatus in the present invention includes a connecting piece (1), a first coaxial cable (2), a second coaxial cable (3) and a grounding lead (4). Said connecting piece (1) includes a first connecting end (11) and a second connecting end (12) on both sides of said connecting piece (1).

Said first coaxial cable (2) includes a first terminal (21) to connect with said first connecting end (11) for transmitting signal. The exteriors of said first terminal (21) and said first connecting end (11) are wrapped with a first protection coating (5).

Said second coaxial cable (3) includes a second terminal (31) to connect said second connecting end (12) for transmitting signal above-mentioned. The exteriors of said second terminal (31) and said second connecting end (12) are wrapped with a second protection coating (6).

Said grounding lead (4) is installed under said connecting piece (1). Said grounding lead (4) must be guided to on the side of metal exposed to the layer surface (not shown in figure) to connect so that can form lightning protection.

By means of structural combination above-mentioned, please refer to FIG. 1 to FIG. 2. The present invention uses the both sides of connecting piece (q) to separately connect with the first terminal (21) of first coaxial cable (2) and the second terminal (31) of second coaxial cable (3), and wrap with the first and second protection coating (5) (6) at the connecting par to achieve the effects below:

1. The present invention can apply to computer network, video, telephone and monitoring equipment, so that can prevent said equipment from instantaneous surge or lightning strike to more directly transmit the input signal and achieve the effect of reducing transmission loss of said signal. When the present invention operates, the stability of circuit system for equipment above-mentioned will not be interfered with lesser power loss.

2. The present invention can enhance the assembly effect to prevent moisture intrusion from breaking owing to instantaneous pressure, which can protect internal components of said lightning arrestor apparatus from damaging and provide good protection.

It is worthy of seeing FIG. 3 and FIG. 4 for the other example of lightning arrestor apparatus in the present invention, which units are basically the same with those in the better example above. For example, both include a first coaxial cable (2) and a first protection coating (5). The difference is only that the design of one end of connecting piece (1) utilizes the concept of the present invention, whereas the design of other end needs to connect with other connecting components (not shown in figure). Although modeling on both sides is slightly different, the requirements to achieve the effect above-mentioned can be achieved.

Further features and advantages of the invention will become apparent from the following description of a preferred embodiment of the invention, although it will be appreciated by those skilled in the art that variations and modifications of the specific embodiment disclosed could be made without departing from the spirit and scope of the invention.

### BRIEF DESCRIPTION OF THE DRAWINGS

FIG. 1 is a combined view of abetter implementing example according to the invention.

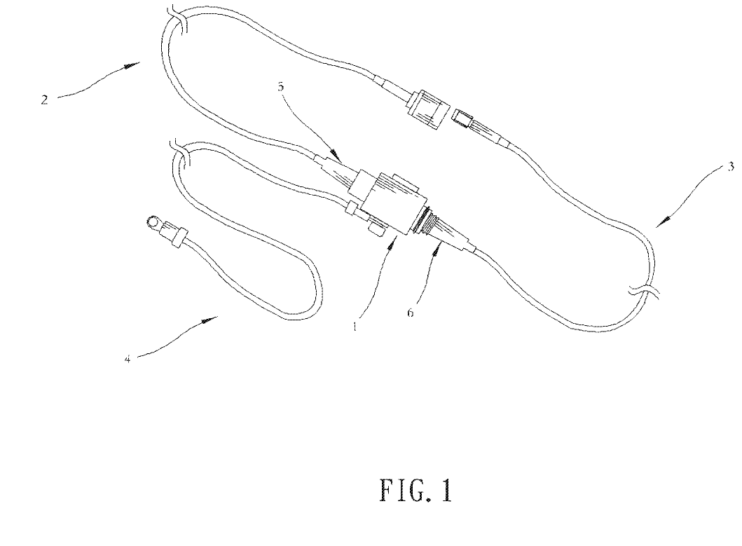

FIG. 2 is a 3D cross-sectional view according to FIG. 1.

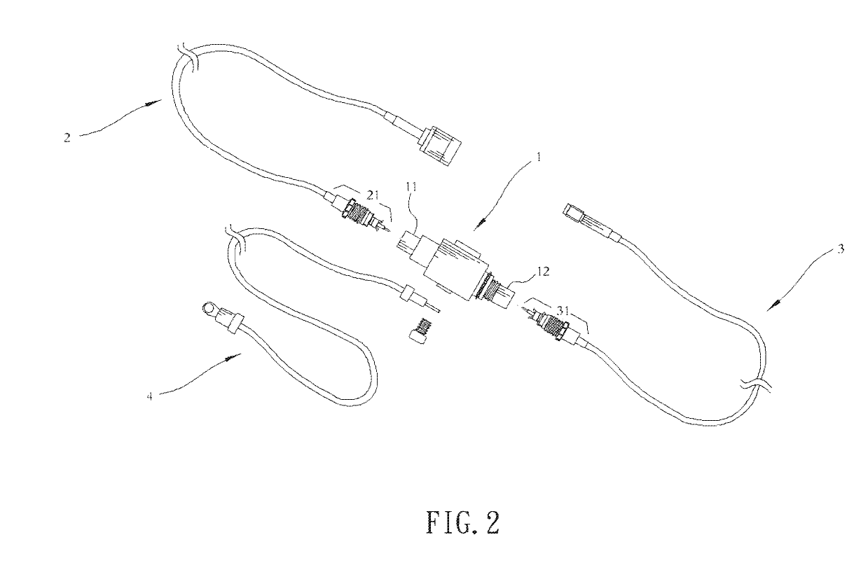

FIG. 3 is a 3D view of a better implementing example according to the invention.

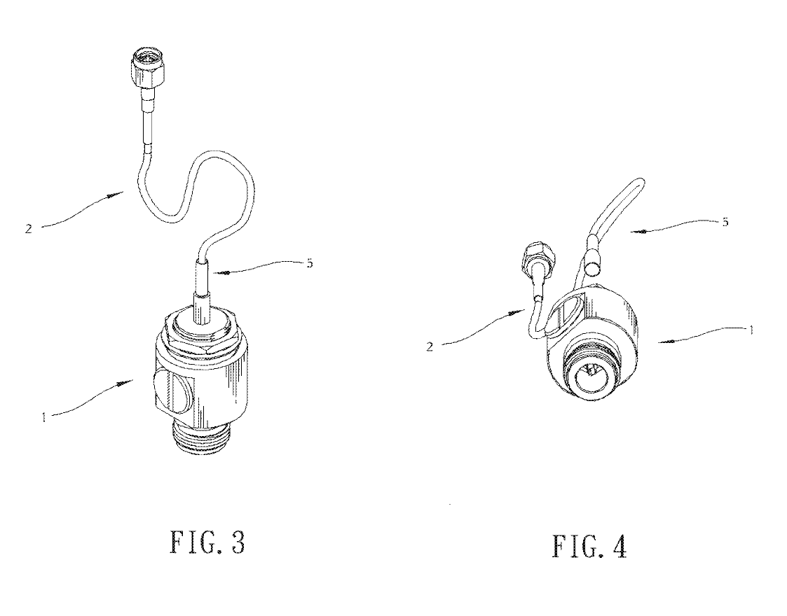

FIG. 4 is a 3D view of a better implementing example. FIG. 5 is a structure schematic view of lightning arrestor.

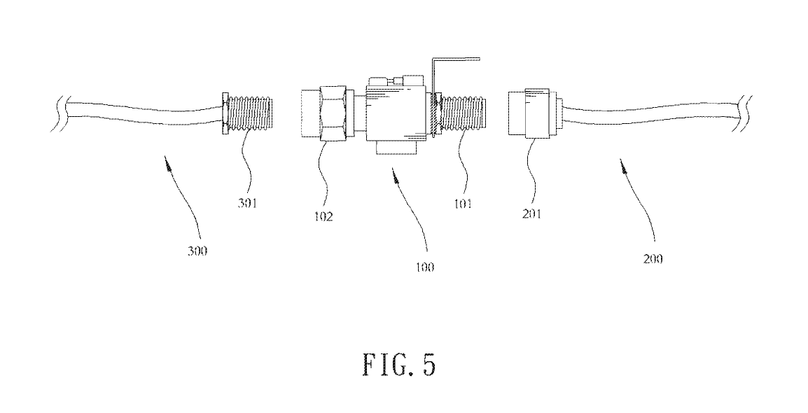

What is claimed is:

1. A lightning arrestor apparatus comprises:
A connecting piece including a first connecting end and a second connecting end on both sides of said connecting piece;
A first coaxial cable including a first terminal to connect said first connecting end for transmitting signal,
A second coaxial cable including a second terminal to connect said second connecting end for transmitting signal above-mentioned; and a grounding lead, which is installed under said connecting piece.

2. An improvement of lightning arrestor apparatus as claimed in claim 1, wherein the exteriors of said first terminal and said first connecting end have been further wrapped with a first protection coating.

3. An improvement of lightning arrestor apparatus as claimed in claim 1, wherein the exteriors of said second terminal and said second connecting end have been further wrapped with a second protection coating.
